(19) United States
(12) Patent Application Publication
(10) Pub. No.: US 2008/0276129 A1
(43) Pub. Date: Nov. 6, 2008

(54) SOFTWARE TRACING

(75) Inventors: Mark Andrew Cocker, Bournemouth (GB); Paul Kettley, Winchester (GB)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/110,378

(22) Filed: Apr. 28, 2008

(30) Foreign Application Priority Data
May 2, 2007 (EP) 07107346.4

(51) Int. Cl. G06F 11/34

(52) U.S. Cl. 714/45; 714/E11.189

(57) ABSTRACT

Trace information is selectively generated for a software routine based on the perceived reliability of the software routine. The software routine includes at least one trace point having an active state and an inactive state. A previously-established reliability indicator for the software routine is read before the routine is executed. The reliability indicator is based on criteria such as age, prior level of testing, source, number or previously detected faults and/or number of prior successful executions. If the reliability indicator meets a predetermined threshold, the active state is selected for the trace point. If the reliability indicator does not meet the predetermined threshold, the inactive state is selected for the trace point.

### BACKGROUND OF THE INVENTION

The present invention relates to tracing software for problem diagnosis. In particular it relates to selectively tracing the operation of a software component based on the perceived reliability of the software component.

Problems can be encountered during the execution of a software application. For example, exceptions to the normal operation of the software application can manifest in many ways, including but not limited to: irregular or undesirable results; erroneous data; interruptions to execution; poor performance; excessive and unnecessary resource utilization; abnormal or premature termination; abnormal state; and a complete failure of the application.

The process of problem determination for such exceptions can involve the use of many tools and techniques. Most notably, capturing information relating to the state of a software application at the point of exception is commonly known. For example, techniques such as First Failure Data Capture (FFDC) can provide an automated snapshot of a system environment when an unexpected internal error occurs. Furthermore, providing memory and state ‘dumps’ in the event of software failure is well known and is common in such software as operating systems.

The inadequacies of such data capture techniques in problem determination are widely known to those skilled in the art, and include the limited scope of the data collected at the point of exception. For example, it is not possible to retrieve state information leading up to an exception using such techniques. To address these deficiencies, software tracing is often employed to monitor and record software application state information at execution time. In this way, a rich set of valuable trace information can be recorded for the entire execution of a software application such that, in the event of an exception, state information for the period leading up to the exception is available to assist in problem determination.

However, recording trace information routinely during the execution of a software application is burdensome and imposes a further resource requirement over and above that of the software application itself, manifesting as a requirement for further storage and processing throughput. In some environments, the burden of generating and recording trace information at execution time can be so great that it exceeds the resource requirements of the software application itself. For this reason, a decision to include facilities for generating and recording trace information in a software application will involve a compromise. The balance is between a resource-efficient, high performance software application and a rich set of trace information for use in the event of exceptions at runtime. However this balance may be established for a particular software application, either performance or reliability will be compromised.

### BRIEF SUMMARY OF THE INVENTION

The present invention may be embodied as a method for selectively generating trace information during execution of software routines. A software routine includes at least one trace point that can be set in an active state in which trace information is generated or an inactive state in which no trace information is generated. A reliability indicator associated with a software routine to be executed is read. If the reliability indicator meets a predetermined threshold, the trace point is set to the active state. If the reliability indicator does not meet the predetermined threshold, the trace point is set to the inactive state.

The present invention may also be embodied as a computer program product for selectively generating trace information during execution of software routines. A software routine includes at least one trace point that can be set in an active state in which trace information is generated or an inactive state in which no trace information is generated. The computer program product includes a computer usable medium embodying computer usable program code. The computer usable program code is configured to read a reliability indicator associated with a software routine to be executed is read, to set the trace point to the active state if the reliability indicator meets a predetermined threshold, and to set the trace point to the inactive state if the reliability indicator does not meet the predetermined threshold.

The present invention may also be embodied as an apparatus for selectively generating trace information during execution of software routines. A software routine includes at least one trace point that can be set in an active state in which trace information is generated or an inactive state in which no trace information is generated. The apparatus includes a read logic module for reading a reliability indicator associated with a software routine to be executed. The apparatus further includes a trace point control logic module that sets the trace point to the active state if the reliability indicator meets a predetermined threshold and to the inactive state if the reliability indicator does not meet the predetermined threshold.

### BRIEF DESCRIPTION OF THE SEVERAL VIEWS OF THE DRAWINGS

FIG. 1 is a block diagram of a computer system suitable for the operation of embodiments of the present invention.

FIG. 2 is a block diagram of a software application in accordance with an embodiment of the present invention.

FIG. 3 is a flowchart of a method in accordance with an embodiment of the present invention.

FIG. 4 is a block diagram of a software application in accordance with an embodiment of the present invention in use.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

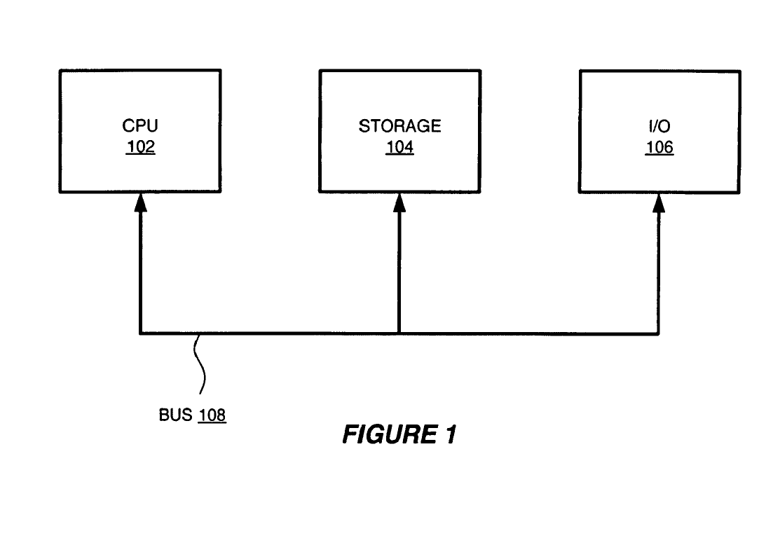

FIG. 1 is a block diagram of a computer system suitable for the operation of embodiments of the present invention. A central processor unit (CPU) 102 is communicatively connected to a storage unit 104 and an input/output (I/O) interface 106 via a data bus 108. The storage unit 104 can be any read/write storage device such as a random access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

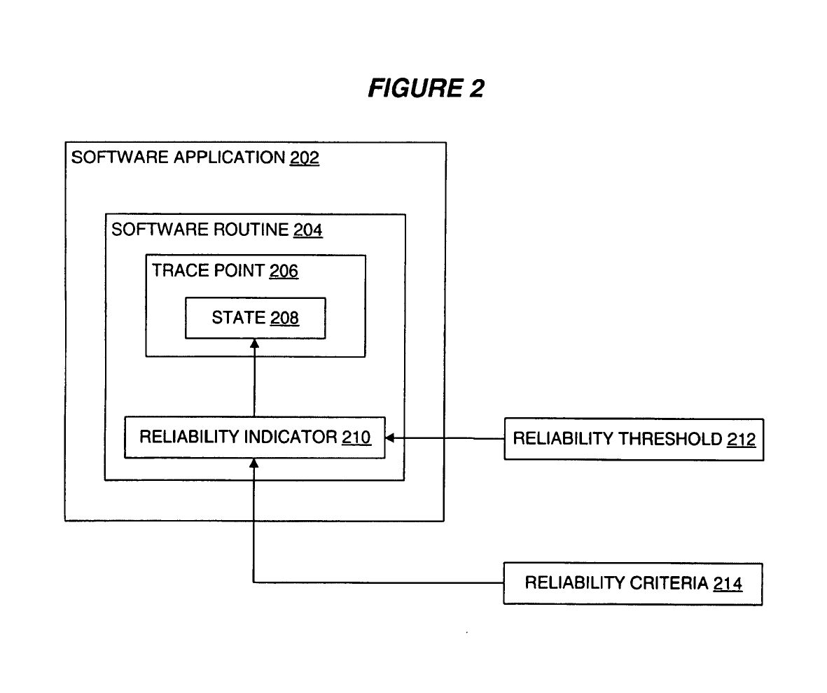

FIG. 2 is a block diagram of a software application 202 in accordance with an embodiment of the present invention. Software application 202 includes a software routine 204. Software routine 204 is an executable software component that is part of or is called by the software application 202. For example, the software routine can be a function, procedure, subroutine, macro, application programming interface routine, program, sub-program, software method or any other executable program component known to those skilled in the art.

Alternatively, software routine 204 can constitute the entirety of the software application 202, in which case no distinction need be drawn between such the software routine 204 and software application 202. In an alternative arrangement, the software application 202 can be a software solution comprising an integration of multiple sub-applications, each sub-application constituting a software routine 204 as illustrated in FIG. 2. Further alternative arrangements of software applications and routines will be apparent to those skilled in the art.

Software routine 204 will include a series of instructions passed to the CPU 102 of a computer system for execution. Alternatively, software routine 204 will include instructions for a runtime environment running on the CPU 102 of a computer system, such as a virtual machine runtime environment, an operating system runtime environment or other runtime environments such as are well known to those skilled in the art.

The software routine is operable to generate trace information such as application progress information, data and memory information, performance information and problem reports. The trace information is generated at a trace point 206 within the software routine 204. Trace point 206 is an identified location within the software instructions of the software routine 204 at which trace information is generated. The trace information can be generated by software instructions located in-line at the trace point 206. Alternatively, an external tracing component can provide facilities for the generation of trace information at the trace point 206.

The trace point 206 has an associated state 208 indicating whether the trace point 206 is active or inactive. In the active state, trace information is generated at trace point 206 during the execution of the software routine 204. In the inactive state, no trace information is generated at trace point 206. In the active state, the generation of trace information will necessarily involve resource overheads such as additional usage of the CPU 102, storage unit 104 and I/O 106. For example, the generation of trace information can require the use of the CPU 102 to execute trace instructions and the use of storage unit 104 to store generated trace data. Such resource overheads can be avoided in the inactive state since no such trace information is generated in the inactive state. However, the absence of such trace information will render servicing the software routine 204 and the software application 202 more difficult.

The software routine 204 further includes a reliability indicator 210. The reliability indicator 210 is an indicator of the apparent reliability of the software routine 204. For example, the reliability indicator 210 can be a numerical quantification of a level of reliability of the software routine 204. The reliability indicator 210 is defined using reliability criteria 214. The reliability criteria 214 define the rules used to determine the reliability indicator 210 and can employ parameters of the software routine 204 to arrive at the reliability indicator 210. Examples of parameters which can be incorporated into the reliability criteria 214 can include:

a) the age of the software routine 204 as older (more mature) software routines may be considered to be more reliable;

b) the level of prior testing of the software routine 204;

c) the source (particular vendor, programmer or designer) of the software routine 204;

d) the number of faults previously recorded for the software routine 204; and/or

e) A number of prior successful executions of the software routine 204.

Notably, the reliability criteria 214 can include rules incorporating any number of these reliability considerations or other such indicators of reliability as will be well known to those skilled in the art.

In one suitable embodiment, the reliability criteria 214 defines the reliability indicator 210 as a numerical indicator or weighted score derived from an identification of the vendor of software routine 204 and the number of reported faults of software routine 204 in the past 12 months. A higher score reflects a higher relative reliability. Such reliability criteria 214 can be expressed as:

RELIABILITY INDICATOR=VENDOR SCORE+FAULT SCORE

where the vendor score and fault score are defined in Tables 1 and 2 below. In this way the reliability indicator 210 represents the perceived reliability of the software routine 204.

TABLE 1

| Vendor | Score |
|---|---|
| w | 20 |
| x | 40 |
| y | 30 |
| z | 10 |

TABLE 2

| # Faults/12 months | Score |
|---|---|
| 0 | 40 |
| 1 to 4 | 30 |
| 5 to 10 | 10 |
| more than 10 | 0 |

The software application 202 is further associated with a reliability threshold 212. The reliability threshold 212 defines a threshold of the reliability indicator 210 at which the state 208 of ‘active’ is selected for the trace point 206. Thus, the reliability threshold 212 is used to specify a level of reliability at which the trace point 206 generates trace information. For example, where the reliability indicator 210 measures reliability using a numerical scale, the reliability threshold 212 defines a numerical level on the scale at which the trace point 206 is activated.

In this way the reliability indicator 210 for a software routine allows the state of the trace point 206 to be aligned with a level of perceived reliability of the software routine 204. Where the level of reliability meets the reliability threshold 212, tracing is activated by setting the state 208 for the trace point 206 to ‘active’. Where the threshold is not met, tracing is inactive by setting the state 208 for the trace point 206 to ‘inactive’. Thus trace information is only generated for the software routine 204 if the software routine 204 does not exhibit a required level of reliability. Accordingly, software routines exhibiting a required level of reliability are excluded from tracing and have a correspondingly lower resource overhead.

It will be appreciated by those skilled in the art that the reliability indicator 210 is useful to indicate an apparent level of reliability of the software routine 204. The reliability indicator 210 can additionally, or alternatively, indicate the reliability, or a level of reliability, of the software routine 204 by way of expressing a lack of reliability. For example, the reliability indicator 210 may indicate on a numerical scale, such as in a range from zero to ten, with values closer to zero indicating a lack of reliability and values closer to ten indicating more reliability.

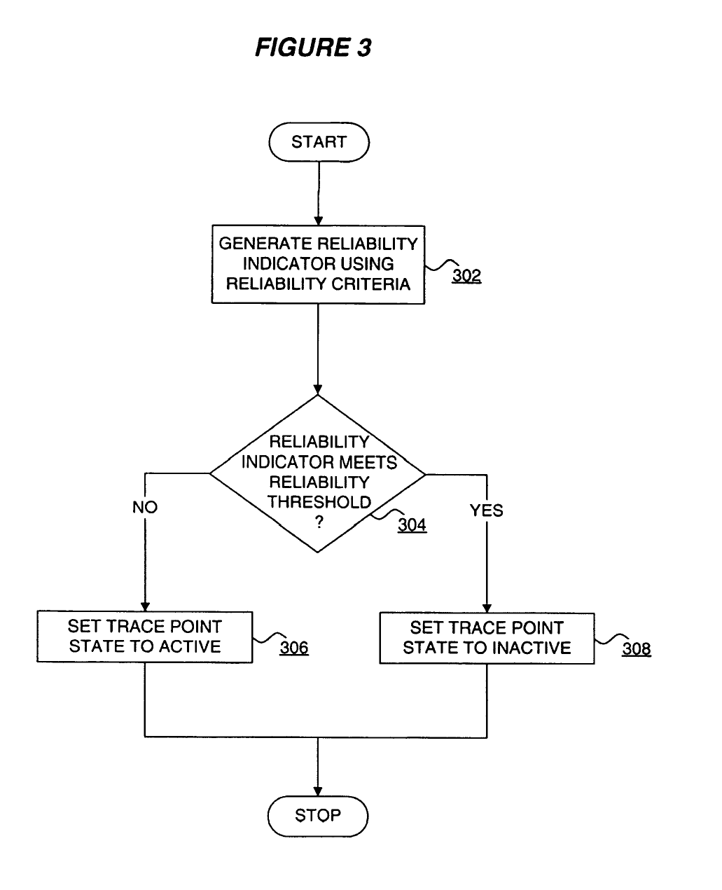

FIG. 3 is a flowchart of a method in accordance with an embodiment of the present invention. At step 302 the reliability indicator 210 is generated using the reliability criteria 214, such as is described above with respect to FIG. 2. At step 304 the method determines if the reliability indicator 210 meets the reliability threshold 212. If the reliability indicator 210 does not meet the reliability threshold 212, the active state 208 is selected for the trace point 206 at step 306. Alternatively, if the reliability indicator 210 does meet the reliability threshold 212, the inactive state 208 is selected for the trace point 206 at step 308.

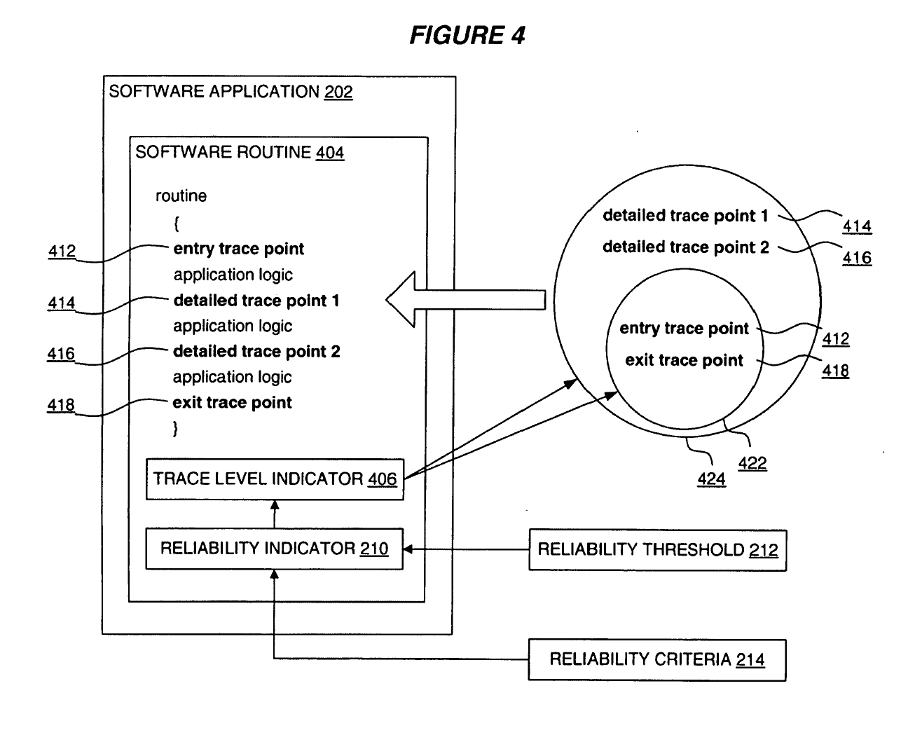

FIG. 4 is a block diagram of a software application in accordance with an exemplary embodiment of the present invention in use. Many of the elements of FIG. 4 are identical to those described with respect to FIG. 2 and these will not be repeated here. The software routine 404 of FIG. 4 includes an entry trace point 412, two detailed trace points 414 and 416, an exit trace point 418 and application logic. The entry and exit trace points 412 and 418 are intended to generate trace information indicating that the software routine 404 was executed (on entry) and terminated (on exit). The detailed trace points 414 and 416 provide more detailed information as to the effectiveness of the execution of the software routine 404 such as data variable values and the flow of the application logic within the software routine 404. Logically, the trace points 412 to 418 can be considered to be organized into sets of trace points 422 and 424 such that all trace points 412 to 418 are organized into a first set of trace points 424 with the entry and exit trace points 412 and 418 organized into a second set of trace points 422 as a subset of the first set 424. This logical organization provides for the definition of different levels of trace for the software routine 404. For example, at one level of trace, only the trace points 412 and 418 in the subset 422 of trace points are active. This might be considered a ‘lower’ level of trace since the detailed trace points 414 and 416 are inactive. At an alternative level of trace, all trace points in set 424 are active. This might be considered a ‘higher’ level of trace since all trace points are active to generate trace information.

The software routine 404 further includes a trace level indicator 406. The trace level indicator 406 identifies one of the sets 422 or 424 of trace points to be used for the generation of trace information during execution of the software routine 404. All trace points contained in the indicated one of the sets 422 and 424 is selected as ‘active’ during execution of the software routine 404. The one of the sets 422 and 424 identified by the trace level indicator 406 is determined using the reliability indicator 210 for the software routine 404. If the reliability indicator 210 meets the reliability threshold 212, the larger set 424 of all trace points 412 to 418 can be selected since the software routine 404 is not considered to be suitably reliable. On the other hand, if the reliability indicator 210 does not meet the reliability threshold 212, the smaller subset 422 of only entry and exit trace points 412 and 418 can be selected since the software routine 404 is considered to be suitably reliable.

In this way the reliability indicator 210 for a software routine allows a level of tracing to be aligned with a level of reliability of the software routine 404. Where the level of reliability meets the reliability threshold 212, tracing is activated at a higher level by the trace level indicator 406 indicating that the larger set 424 of trace points should be selected as active. Where the threshold is not met, tracing is activated at a lower level by the trace level indicator 406 indicating that the smaller set 422 of trace points should be selected as active. Thus trace information is generated for the software routine 404 in accordance with a relative level of reliability of the software routine 404.

Embodiments of the present invention therefore consider the perceived reliability of a software routine in establishing the level of tracing for the software routine so that more reliable software routines have lower levels of tracing and correspondingly lower tracing resource overhead.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for selectively generating trace information during execution of software routines, each having at least one trace point, each trace point having an active state in which trace information is generated and an inactive state in which no trace information is generated, the method comprising the steps of:
reading a reliability indicator for a software routine to be executed, the reliability indicator corresponding to an assessment of the reliability of the software routine;
in response to a determination that the reliability indicator meets a predetermined threshold, selecting the active state for the trace point; and
in response to a determination that the reliability indicator does not meet the predetermined threshold, selecting the inactive state for the trace point.

2. The method of claim 1 wherein the trace point is a member of a set of trace points, said set of trace points including at least one trace point that remains in an active state without regard to the value of the reliability indicator.

3. The method of claim 2 wherein the trace point that remains in an active state comprises at least one of a trace point that is called at the start of execution of the software routine and a trace point that is called at the end of execution of the software routine.

4. The method of claim 1 wherein the value of the reliability indicator is based at least in part on the age of the software routine.

5. The method of claim 1 wherein the value of the reliability indicator is based at least in part on the level of testing of the software routine.

6. The method of claim 1 wherein the value of the reliability indicator is based at least in part on the identity of the source of the software routine.

7. The method of claim 1 wherein the value of the reliability indicator is based at least in part on a count of a number of faults previously identified in the software routine.

8. The method of claim 1 wherein the value of the reliability indicator is based at least in part on a number of successful prior executions of the software routine.

9. A computer program product for selectively generating trace information during execution of software routines, each having at least one trace point, each trace point having an active state in which trace information is generated and an inactive state in which no trace information is generated, the computer program product comprising a computer usable medium having computer usable program code embodied therewith, the computer usable program code comprising:
computer usable program code configured to read a reliability indicator for a software routine to be executed, the reliability indicator corresponding to an assessment of the reliability of the software routine;
computer usable program code configured to, in response to a determination that the reliability indicator meets a predetermined threshold, select the active state for the trace point; and
computer usable program code configured to, in response to a determination that the reliability indicator does not meet the predetermined threshold, select the inactive state for the trace point.

10. The computer program product of claim 9 wherein the trace point is a member of a set of trace points, said set of trace points including at least one trace point that remains in an active state without regard to the value of the reliability indicator.

11. The computer program product of claim 10 wherein the trace point that remains in an active state comprises at least one of a trace point that is called at the start of execution of the software routine and a trace point that is called at the end of execution of the software routine.

12. The computer program product of claim 9 wherein the value of the reliability indicator is based at least in part on the age of the software routine.

13. The computer program product of claim 9 wherein the value of the reliability indicator is based at least in part on the level of testing of the software routine.

14. The computer program product of claim 9 wherein the value of the reliability indicator is based at least in part on the identity of the source of the software routine.

15. The computer program product of claim 9 wherein the value of the reliability indicator is based at least in part on a count of a number of faults previously identified in the software routine.

16. The computer program product of claim 9 wherein the value of the reliability indicator is based at least in part on a number of successful prior executions of the software routine.

17. An apparatus for selectively generating trace information during execution of software routines, each having at least one trace point, the trace point having an active state in which trace information is generated and an inactive state in which no trace information is generated, the apparatus comprising:
a read logic module for retrieving a stored reliability indicator for a software routine to be executed, the reliability indicator corresponding to an assessment of the reliability of the software routine;
a trace point control logic module for selecting the active state for the trace point in response to a determination that the reliability indicator meets a predetermined threshold and the inactive state in response to a determination that the reliability indicator does not meet the predetermined threshold.

18. The apparatus of claim 17 wherein the trace point is a member of a set of trace points, said set of trace points including at least one trace point that remains in an active state without regard to the value of the reliability indicator.

19. The apparatus of claim 18 wherein the trace point that remains in an active state comprises at least one of a trace point that is called at the start of execution of the software routine and a trace point that is called at the termination of execution of the software routine.

20. The apparatus of claim 17 wherein the value of the reliability indicator is based at least in part on the age of the software routine.

21. The apparatus of claim 17 wherein the value of the reliability indicator is based at least in part on the level of testing of the software routine.

22. The apparatus of claim 17 wherein the value of the reliability indicator is based at least in part on the identity of the source of the software routine.

23. The apparatus of claim 17 wherein the value of the reliability indicator is based at least in part on a count of a number of faults previously identified in the software routine.

24. The apparatus of claim 17 wherein the value of the reliability indicator is based at least in part on a number of successful prior executions of the software routine.
